(19) United States
(12) Patent Application Publication
(10) Pub. No.: US 2013/0001014 A1
(43) Pub. Date: Jan. 3, 2013

(54) METHOD OF STABILIZING A PORTABLE LADDER

(76) Inventor: Dan Halloran, Broadalbin, NY (US)

(21) Appl. No.: 13/539,539

(22) Filed: Jul. 2, 2012

Related U.S. Application Data
(60) Provisional application No. 61/503,700, filed on Jul. 1, 2011.

(51) Int. Cl. E06C 7/18; B23P 17/00; B23P 11/00

(52) U.S. Cl. 182/107; 29/525.01; 29/525.03

(57) ABSTRACT

An improved apparatus and method for stabilizing a portable ladder is provided by this invention. The use of through rung functionality of a portable ladder securing device reduces the probability of a person climbing the portable ladder falling from the portable ladder or a person on the ground from being struck by an object falling from a portable ladder. The apparatus and method include the use of stabilizing arms that are attached to the portable ladder either by a brace or a through-rung component. Furthermore, the apparatus and method include a second section for securing the stabilizing arms either to a nearby stable structure or to an integrated ground spike component. The stabilizing arms are adjustable in length allowing for the proper use of the portable ladder stabilizing apparatus in a greater amount of environmental conditions.

### CROSS-REFERENCE TO RELATED APPLICATION

This application claims the benefit of provisional patent application No. 61/503,700 entitled “AN IMPROVED METHOD OF STABILIZING A PORTABLE LADDER”, filed Jul. 1, 2011, the entire contents of which are herein incorporated by reference.

### FIELD OF THE INVENTION

The present invention relates to an apparatus and methods for stabilizing a portable ladder. More specifically, this invention relates to apparatus and methods that are useful in stabilizing a portable ladder utilizing bracing components that are attached to the lower portion of the portable ladder and to the ground or a nearby structure.

### BACKGROUND OF THE INVENTION

Use of portable ladders to access high structures on professional construction sites to non-professional home improvement work involves hazardous activities. The hazards can include persons or construction materials falling from a portable ladder or persons or materials being struck by a falling ladder. Even with the use of a recommended 4:1 rule, in that the distance between the ladder base and the structure it is resting up against be at least 25% of the structure height, these hazardous results can still occur due to wet ground surfaces, unstable ground material, or other environmental conditions.

As cited by the U.S. Occupational Safety & Health Administration's website, “Falls from portable ladders (step, straight, combination and extension) are one of the leading causes of occupational fatalities and injuries.”

Devices to anchor the base of portable ladders in the market are currently lacking in both availability and capabilities. Use of this improved method for stabilizing a portable ladder can decrease the risk associated with utilizing a portable ladder.

Useful Definitions:

LADDER: A structure for climbing up or down that consists essentially of two long sidepieces joined at intervals by crosspieces on which one may step.

STRINGER: One of two long sidepieces joined at intervals by crosspiece rungs to comprise a ladder.

RUNG: One of the crosspieces of a ladder.

### SUMMARY OF THE INVENTION

An improved apparatus and method for stabilizing a portable ladder is provided by this invention. The use of through rung functionality of a portable ladder securing device reduces the probability of a person climbing the portable ladder falling from the portable ladder or a person on the ground from being struck by an object falling from a portable ladder. The apparatus and method include the use of stabilizing arms that are attached to the portable ladder either by a brace or a through-rung component. Furthermore, the apparatus and method include a second section for securing the stabilizing arms either to a nearby stable structure or to an integrated ground spike component. The stabilizing arms are adjustable in length allowing for the proper use of the portable ladder stabilizing apparatus in a greater amount of environmental conditions.

A first aspect of the present invention provides a method for stabilizing a portable ladder, the method comprising: attaching one end of a stabilizing arm component to a stabile component; adjusting a length of said stabilizing arm; and connecting an opposite end of said stabilizing arm to a said lower half of said portable ladder comprises a stabilizing arm component that goes through an inside of a portable ladder rung.

A second aspect of the present invention provides a portable ladder stabilizing system, comprising: a portable ladder for stabilizing; a module for attaching a portable ladder stabilizing device to a stabilizing arm component that goes through an inside of a portable ladder rung; a module for adjusting a length of said stabilizing arm; and a module for connecting an opposite end of said stabilizing arm to a stabile component.

The present invention provides a novel method and apparatus for stabilizing a portable ladder. To attain this, the present invention utilizes stabilizing arms that can attach to the stringer or stringer and a rung of the portable ladder. The opposing ends attach to either a secure structure nearby or to another component of the apparatus that can be placed in nearby ground. The portion of the apparatus that spans between the portable ladder and either the secure structure or ground has an adjustable length. This adjustable length allows the user to vary the distance between the lower portion of the portable ladder and the vertical structure the ladder is resting against. This is important for two reasons: First, a general guideline exists where the distance between the bottom of a ladder and the nearby structure is 25% of the height at which the top portion of the ladder is resting against the structure. Second, when utilizing the ground-securing component, it is advantageous to be able to adjust the distance at which the ground-securing component is placed in the ground, relative to the base of the portable ladder, such that a suitable portion of earth can be found to place the ground-securing component into.

In one embodiment, the apparatus utilizes a ground spike. The ground spike is connected to a first arm component that is then connected to a second arm component via a set of pins and drilled holes in the first arm and second arm components. The second arm component has one end that is attached to a combination of the portable ladder stringer and one of the portable ladder's rungs.

In another embodiment, the apparatus utilizes a ground spike. The ground spike is connected to a first arm component that is then connected to a second arm component via a set of pins and drilled holes in the first arm and second arm components. The second arm component includes a rod or bar that has a 90 degree turn that then extends through the inner portion of one of the portable ladder's rungs. It can either include a block/locking component on the opposite end of the ladder rung or have a symmetric set of connecting portable ladder-stabilizing components that attach to a second ground spike.

In another embodiment, the apparatus utilizes an attachment to the stable vertical structure that the portable ladder is resting against and which a higher level is being accessed via the portable ladder. A building securing component is connected to a first arm component that is then connected to a second arm component via a set of pins and drilled holes in the first arm and second arm components. The second arm component has one end that is attached to a combination of the portable ladder stringer and one of the portable ladder's rungs.

In another embodiment, the apparatus utilizes an attachment to the stable vertical structure that the portable ladder is resting against and which a higher level is being accessed via the portable ladder. A building securing component is connected to a first arm component that is then connected to a second arm component via a set of pins and drilled holes in the first arm and second arm components. The second arm component has one end that is attached to a combination of the portable ladder stringer and one of the portable ladder's rungs.

In another embodiment, the apparatus utilizes a ‘j-hook’ component that is inserted into an opening in the stable vertical structure that the portable ladder is resting against. The opening can be an open window. A building securing component is connected to a first arm component that is then connected to a second arm component via a set of pins and drilled holes in the first arm and second arm components. The second arm component has one end that is attached to a combination of the portable ladder stringer and one of the portable ladder's rungs. The first arm component rests on the bottom of the stable vertical structure opening and includes a portion that extends inside the vertical structure, protrudes away from the opening in the stable vertical structure, and comes into contact with the inside wall of the stable vertical structure. This limits the portable ladder base from moving away from the stable vertical structure. The first arm component could further include an adjustable component that is placed immediately outside of the opening in the stable vertical structure and comes into contact with the outer wall of the stable vertical structure, thus limiting the portable ladder base from moving towards the stable vertical structure.

These and other objects of the embodiments of the present invention as described below will be evident from the following description, which is illustrative only and does not restrict the spirit and scope of the invention, which is to be measured solely by the claims.

### BRIEF DESCRIPTION OF THE DRAWINGS

These and other features of the invention will be more readily understood from the following description of the various aspects of the invention taken in conjunction with the accompanying drawings in which:

FIG. 1 shows a diagram of the portable ladder securing device according to one embodiment of this invention;

FIG. 2 shows a diagram of the portable ladder securing device according to another embodiment of this invention;

FIG. 3 shows a side view of the portable ladder securing device according to another embodiment of this invention;

FIG. 4 shows a side view of the portable ladder secured to a ground spike according to another embodiment of this invention; and

FIG. 5 also shows a diagram of the portable ladder securing device according to another embodiment of this invention.

The drawings are not necessarily to scale. The drawings are merely a schematic representation, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

An improved apparatus and method for stabilizing a portable ladder is provided by this invention. The use of through rung functionality of a portable ladder securing device reduces the probability of a person climbing the portable ladder falling from the portable ladder or a person on the ground from being struck by an object falling from a portable ladder. The apparatus and method include the use of stabilizing arms that are attached to the portable ladder either by a brace or a through-rung component. Furthermore, the apparatus and method include a second section for securing the stabilizing arms either to a nearby stable structure or to an integrated ground spike component. The stabilizing arms are adjustable in length allowing for the proper use of the portable ladder stabilizing apparatus in a greater amount of environmental conditions.

Embodiments of this invention are directed to an apparatus and methods for stabilizing a portable ladder.

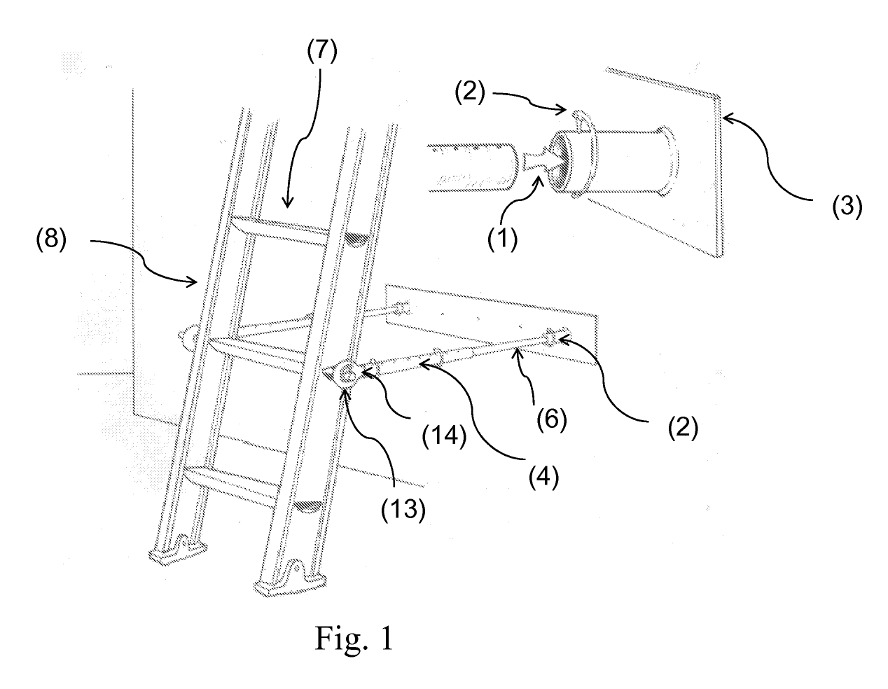

Referring now to FIG. 1, a multi-component configuration according to one embodiment of the invention is depicted. The second portion (4) of the portable ladder securing apparatus includes a sub-component (13) for attaching the portable ladder securing apparatus through one rung (7), of the portable ladder, and is connected to the second portion of a second portable ladder securing apparatus. The sub-component (13) further includes a securing pin (14) to secure the sub-component (13) to the second portion (4) of the portable ladder securing apparatus. The first portion (6) of the portable ladder securing apparatus includes a circular opening (1) that is attached to the stabile structure which the top portion of the portable ladder is resting against. A second securing pin (14) is used to secure the first portion (6) of the portable ladder apparatus to the sub-component (3) that can be attached to the stabile structure which the top portion of the portable ladder is resting against.

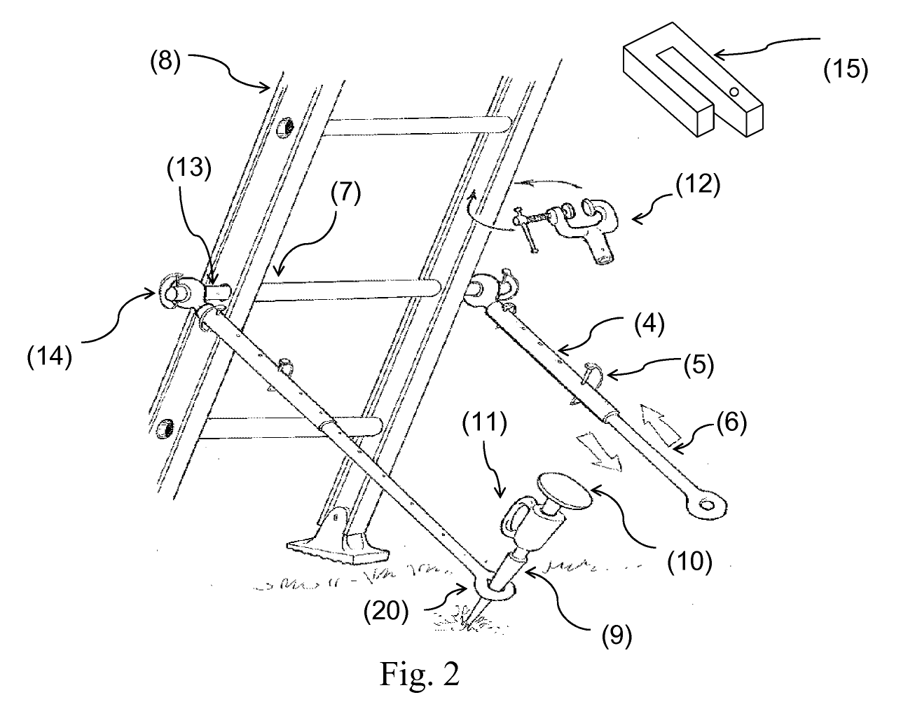

Referring now to FIG. 2, another multi-component configuration according to another embodiment of the invention is depicted. The second portion (4) of the portable ladder securing apparatus includes a sub-component (13) for attaching the portable ladder securing apparatus through one rung (7), of the portable ladder, and is connected to the second portion of a second portable ladder securing apparatus. The sub-component (13) further includes a securing pin (14) to secure the sub-component (13) through a rung (7) of the portable ladder. The first portion (6) of the portable ladder securing apparatus includes a circular opening (20) that a ground spike (9) is placed through for securing the first portion (6) of the portable ladder securing apparatus to the ground. The ground spike (9) has a flat surface (10) for striking the ground spike (9) when installing the ground spike (9) into the earth. The ground spike (9) also has a handle component (11) that is used to remove the ground spike (9) from the earth. The length of the first portion (6) and second portion (4) of the ladder securing device is adjusted through the use of a length varying pin (5) in combination with aligned openings in both the first portion (6) and the second portion (4) of the ladder securing device. An alternative c-clamp (12) is also shown that can be used as an alternative to the sub-component (13). A second alternative securing bracket (15) is shown that can also be used as an alternative to sub component (13) for connecting the portable ladder securing device to a portable ladder.

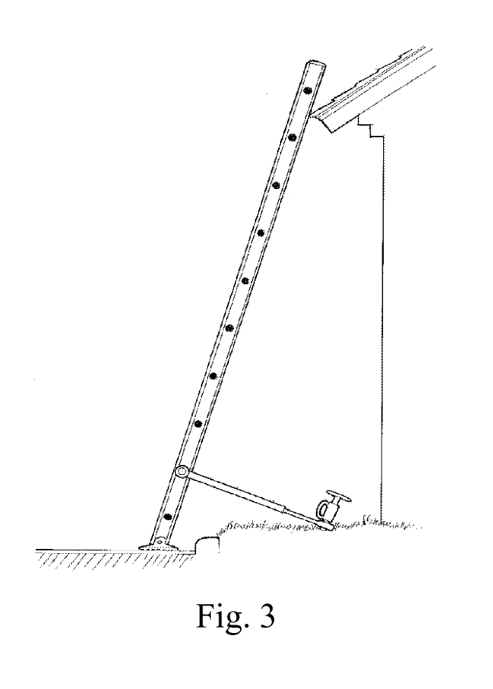

Referring now to FIG. 3, a side view of the portable ladder securing device as also shown in FIG. 2 is depicted. This illustration further exemplifies the ability of this invention to secure a portable ladder when the base of the portable ladder is placed on a hard surface and the portable ladder securing apparatus allows the ground spike to be placed between the portable ladder and the stable structure the upper portion of the portable ladder is resting against.

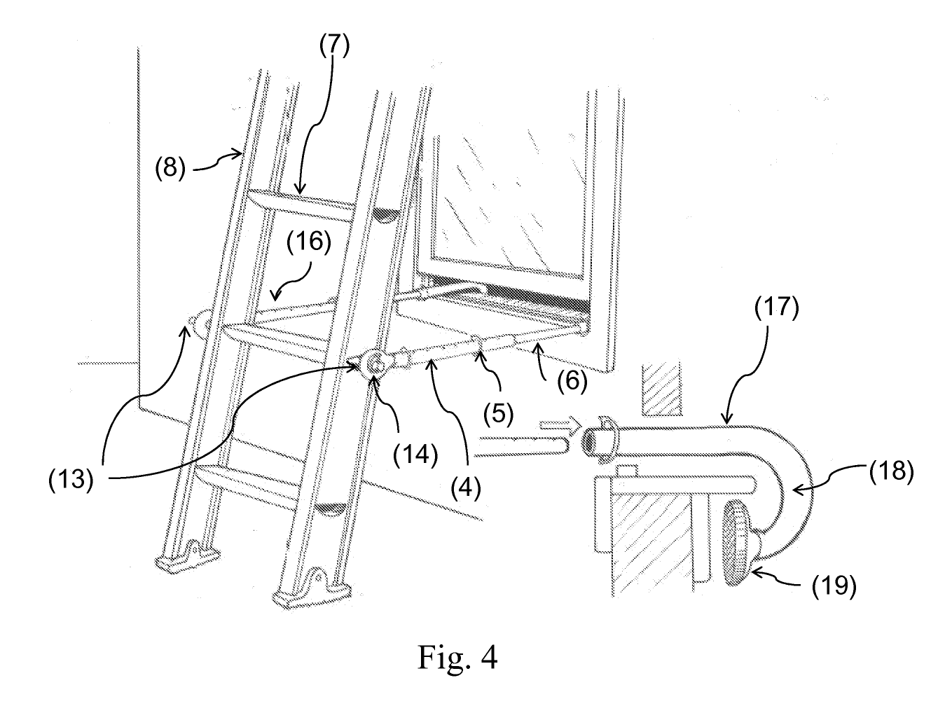

Referring now to FIG. 4, another multi-component configuration according to another embodiment of the invention is depicted. The second portion (4) of the portable ladder securing apparatus includes a sub-component (13) for attaching the portable ladder securing apparatus through one rung (7) of the portable ladder, and is connected to the second portion (16) of a second portable ladder securing apparatus. The sub-component (13) further includes a securing pin (14) to secure the sub-component (13) through a rung (7) of the portable ladder. The first portion (6) of the portable ladder securing apparatus includes additional holes for inserting the first portion (6) into a sub-component (17). Sub-component (17) is inserted into an opening in the stabile structure the top portion of the portable ladder is resting against. The sub-component (17) includes a rounded portion (18) and a flat surface (19) that makes contact with the inner wall of the stabile structure. The length of the first portion (6) and second portion (4) of the ladder securing device is adjusted through the use of a length varying pin (5) in combination with aligned openings in both the first portion (6) and the second portion (4) of the ladder securing device.

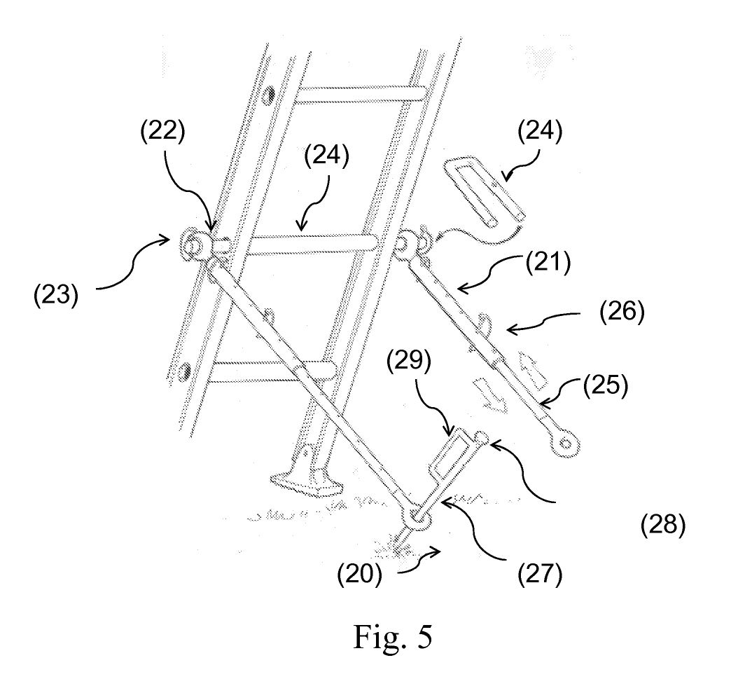

Referring now to FIG. 5, another multi-component configuration according to another embodiment of the invention is depicted. The second portion (21) of the portable ladder securing apparatus includes a sub-component (22) for attaching the portable ladder securing apparatus through one rung (24), of the portable ladder, and is connected to the second portion of a second portable ladder securing apparatus. The sub-component (22) further includes a securing pin (23) to secure the sub-component (22) through a rung (24) of the portable ladder. The first portion (25) of the portable ladder securing apparatus includes a circular opening (20) that a ground spike (27) is placed through for securing the first portion (25) of the portable ladder securing apparatus to the ground. The ground spike (27) has a flat surface (28) for striking the ground spike (27) when installing the ground spike (27) into the earth. The ground spike (27) also has a handle component (29) that is used to remove the ground spike (27) from the earth. The length of the first portion (25) and second portion (21) of the ladder securing device is adjusted through the use of a length varying pin (26) in combination with aligned openings in both the first portion (25) and the second portion (21) of the ladder securing device. A second alternative securing bracket (24) is shown that can also be used as an alternative to sub component (22) for connecting the portable ladder securing device to a portable ladder.

Those skilled in the art will appreciate that more or less steps such as those shown in and described above may be used. For example, a bolt can be used in place of either the length varying pin (5) or the securing pin (14). For another example, square metal components can be used in place of the round metal components for the first portion (6) of the portable ladder securing apparatus, second portion (4) of the portable ladder securing apparatus, and sub-component (13). For another example, the portable ladder securing device can extend away from the stable structure such that the ground spike (9) is placed further away from the stable structure than the base of the portable ladder.

It is apparent that there has been provided with this invention an apparatus and methods for stabilizing a portable ladder. While the invention has been particularly shown and described in conjunction with a preferred embodiment thereof, it will be appreciated that variations and modifications will occur to those skilled in the art. Hence the embodiments shown and described in the drawings and the above discussion are merely illustrative and do not limit the scope of the invention as defined in the claims herein.

What is claimed is:

1. A method for stabilizing a portable ladder, the method comprising:
attaching one end of a stabilizing arm component to a stabile component;
adjusting a length of said stabilizing arm; and
connecting an opposite end of said stabilizing arm to a said lower half of said portable ladder comprises a stabilizing arm component that goes through an inside of a portable ladder rung.

2. The portable ladder stabilizing method according to claim 1, wherein the attaching one end of said stabilizing arm to said lower half of said portable ladder comprises a stabilizing arm component that attaches around a portable ladder stringer and an outside surface of an attached portable ladder rung.

3. The portable ladder stabilizing method according to claim 1, wherein the adjusting the length of said stabilizing arm comprises adjustment of pin components through a plurality of holes in two separate subcomponents of said stabilizing arm.

4. The portable ladder stabilizing method according to claim 1, wherein the connecting the opposite end of said stabilizing arm to said stabile component comprises connecting said opposite end to a building structure that the top of said portable ladder is rested against.

5. The portable ladder stabilizing method according to claim 1, wherein the connecting the opposite end of said stabilizing arm to a stabile component comprises connecting said opposite end to a ground spike component.

6. The portable ladder stabilizing method according to claim 6, wherein said ground spike component includes a flat top surface for striking to insert said ground spike into a ground area.

7. The portable ladder stabilizing method according to claim 6, wherein said ground spike component includes a handle component for removing said ground spike from a ground area.

8. The portable ladder stabilizing method according to claim 1, wherein the connecting the opposite end of said stabilizing arm to a stabile component comprises placing said opposite end into an opening in the building structure that the top of said portable ladder is rested against.

9. The portable ladder stabilizing method according to claim 9, wherein said opposite end includes a rounded extension that contacts an inside wall of the building structure that the top of said portable ladder is rested against.

10. The portable ladder stabilizing method according to claim 1, wherein the attaching one end of said stabilizing arm to said lower half of said portable ladder comprises a stabilizing arm component that goes around a stringer of said portable ladder and rests on a rung of said portable ladder.

11. A portable ladder stabilizing system, comprising:
a portable ladder for stabilizing;
a module for attaching a portable ladder stabilizing device to a stabilizing arm component that goes through an inside of a portable ladder rung;
a module for adjusting a length of said stabilizing arm; and
a module for connecting an opposite end of said stabilizing arm to a stabile component.

12. The portable ladder stabilizing system according to claim 11, wherein the attaching one end of a stabilizing arm to said lower half of said portable ladder comprises a stabilizing arm component that goes through an inside of a portable ladder rung.

13. The portable ladder stabilizing system according to claim 11, wherein the attaching one end of said stabilizing arm to said lower half of said portable ladder comprises a stabilizing arm component that attaches around a portable ladder stringer and an outside surface of an attached portable ladder rung.

14. The portable ladder stabilizing system according to claim 11, wherein the adjusting the length of said stabilizing arm comprises adjustment of pin components through a plurality of holes in two separate subcomponents of said stabilizing arm.

15. The portable ladder stabilizing system according to claim 11, wherein the connecting the opposite end of said stabilizing arm to said stabile component comprises connecting said opposite end to a building structure that the top of said portable ladder is rested against.

16. The portable ladder stabilizing system according to claim 11, wherein the connecting the opposite end of said stabilizing arm to a stabile component comprises connecting said opposite end to a ground spike component.

17. The portable ladder stabilizing system according to claim 16, wherein said ground spike component includes a flat top surface for striking to insert said ground spike into a ground area.

19. The portable ladder stabilizing system according to claim 16, wherein said ground spike component includes a handle component for removing said ground spike from a ground area.

19. The portable ladder stabilizing method according to claim 11, wherein the connecting the opposite end of said stabilizing arm to a stable component comprises placing said opposite end into an opening in the building structure that the top of said portable ladder is rested against.

20. The portable ladder stabilizing method according to claim 11, wherein the attaching one end of said stabilizing arm to said lower half of said portable ladder comprises a stabilizing arm component that goes around a stringer of said portable ladder and rests on rung of said portable ladder.
